(19) United States
(12) Patent Application Publication
(10) Pub. No.: US 2020/0364996 A1
(43) Pub. Date: Nov. 19, 2020

(54) DELIVERY PACKAGE ALARM SYSTEM

(71) Applicant: John Sollars, Pacifica, CA (US)

(72) Inventor: John Sollars, Pacifica, CA (US)

(21) Appl. No.: 16/662,190

(22) Filed: Oct. 24, 2019

Related U.S. Application Data
(60) Provisional application No. 62/847,802, filed on May 14, 2019.

(51) Int. Cl. G08B 13/14; G08B 3/10; G08B 25/10

(52) U.S. Cl. CPC G08B 13/1472; G08B 3/10; G01S 19/13; G08B 25/10; G08B 13/1436

(57) ABSTRACT

A delivery package alarm is described. The delivery package alarm includes a body portion, a weight sensor coupled to and supported by the body portion, and a display coupled to the body and providing information about status of the device. The delivery package alarm also includes at least one electrical connection for an extension grid for holding and sensing additional packages and an audio output device coupled within the body. The delivery package alarm further includes a processing device within the body and configured with computer software to identify, based on information from the weight sensor, the presence of a package being delivered, and the processing device configured to detect when the package is removed and produce an alarm sound through the audio output.

### REFERENCE TO RELATED APPLICATIONS

This application claims priority to U.S. Provisional Application No. 62/847,802 filed on May 14, 2019 entitled DELIVERY PACKAGE ALARM to inventor John Louis Sollars, the entirety of which is herein incorporated by reference in its entirety.

### BACKGROUND

In today's world of e-commerce retail, many packages containing both low and high value goods are delivered to homes each and every day. These services are very attractive to people who are working or carry very busy schedules. Thus, when the packages are delivered people are most often not home to receive the packages. A delivery person often will leave the packages on a front step, front entryway, or front porch. These packages are often very visible to passersby and provide a temptation for theft by desperate people. When people's packages are stolen, they are often, but not always able to get their money back on their goods either through the retailer or through the courier. However, some goods are not refundable and once stolen, thieves may often return so people then may have to make other arrangements for delivery of their packages.

Accordingly, there is a need for a system which allows delivery drivers to easily drop off packages at a home residence without entering their premises. There is also a need for a system which allows for an alarm goes off if a package is attempted to be stolen. There is also a need for a system which allows for an alert to be sent to a homeowner or authorities if a package is being stolen. There is further a need for a system which has devices that attempt to identify a person trying to steal a package. Yet further still there is a need for a system that allows for logging of packages delivered.

### SUMMARY

An exemplary embodiment relates to a delivery package alarm. The delivery package alarm includes a body portion, a weight sensor coupled to and supported by the body portion, and a display coupled to the body and providing information about status of the device. The delivery package alarm also includes at least one electrical connection for an extension grid for holding and sensing additional packages and an audio output device coupled within the body. The delivery package alarm further includes a processing device within the body and configured with computer software to identify, based on information from the weight sensor, the presence of a package being delivered, and the processing device configured to detect when the package is removed and produce an alarm sound through the audio output.

Another exemplary embodiment relates to a delivery package alarm system. The delivery package alarm system includes a body portion, a weight sensor coupled to and supported by the body portion, and a display coupled to the body and providing information about status of the device. The delivery package alarm system also includes an RF communication circuit and an audio output device coupled within the body. The delivery package alarm system further includes a processing device within the body and configured with computer software to identify, based on information from the weight sensor, the presence of a package being delivered, and the processing device configured to detect when the package is removed and produce an alarm sound through the audio output, communicate with an external camera using the RF communication circuit to begin taking pictures.

Yet another exemplary embodiment relates to a method of alerting that a package is being stolen. The method includes detecting from a weight sensor that a package has been removed from an electronic weighing device and producing an audible alarm using an audio output of the weighing device. The method also includes requesting by the weighing device that external cameras begin recording. The method further includes alerting, by the weighing device, a mobile device that a package has been removed; and alerting, by the weighing device, an authority that a package has been removed.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a Delivery Package Alarm Device.

FIG. 2 is an exemplary embodiment of a Delivery Package Alarm System using the Delivery Package Alarm Device of FIG. 1.

The use of the same symbols in different drawings typically indicates similar or identical items unless context dictates otherwise.

### DETAILED DESCRIPTION

Exemplary embodiments provided are configured to stops people from stealing packages from the front door of homes. In accordance with an exemplary embodiment, a delivery driver may place a package on an exemplary device. Once the package is placed on the device, a motion sensor alarm is activated, this action activates a Wi-Fi connection and that activates an alarm—the owner is notified via an app on their smartphone.

If an unauthorized person attempts to steal a package by lifting it from the device, the weight sensor alarm will activate a 100-decibel alarm, for example. Such an alarm would likely be enough to scare the criminal away.

In accordance with an exemplary embodiment, a sensor within the device will accept the additional weight of additional packages without activating the alarm. Any reduction in weight will activate the alarm. In an exemplary embodiment an extension grid is used to expand the device for accepting extra packages. The extension grid supplements the device and expands the coverage area and the number of packages that are accepted. In an exemplary embodiment, the alarm may contain loud verbal exclamations rather than the typical piercing ring. The device may also be connected to an app that you can download from the app store.

In accordance with an exemplary embodiment, the sensor within the device will accept additional weight of additional packages without activating the alarm. Any reduction in weight will activate the alarm.

In accordance with an exemplary embodiment, the device may be comprised of the following, although not limited to the following list:
1. Hard plastic outer case with a slight convex shape
2. LED Screen
3. 110 Decibel Alarm
4. Motion Sensor
5. Weight Sensor
6. Motherboard
7. Computer Processor
8. Network Card NIC
9. Lithium Battery with Charger
10. Weather Resistant Seal
11. GPS Tracker
12. Power Button
13. Grid extension
14. Grid extension electrical

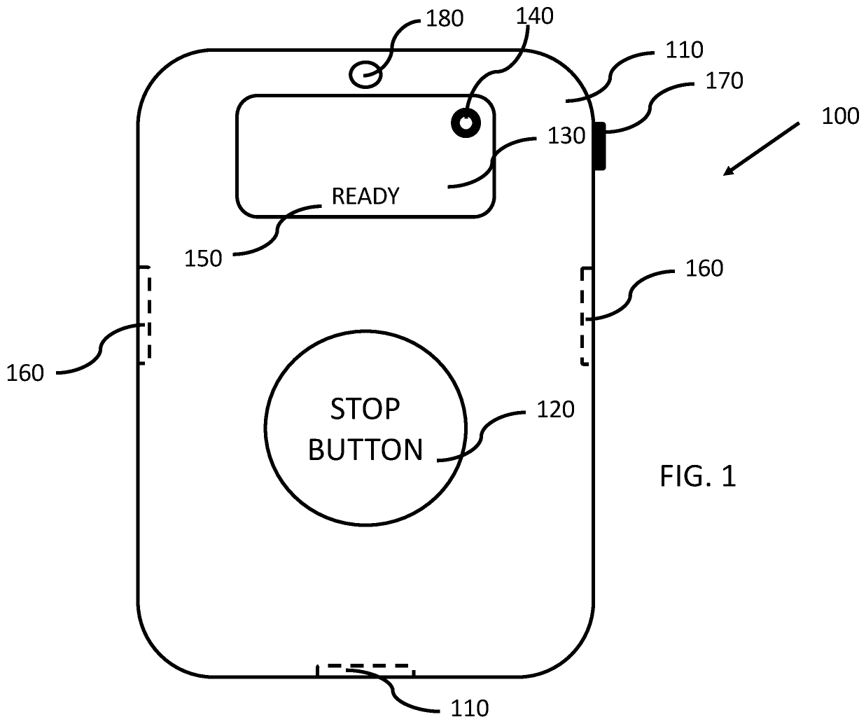

Referring now to FIG. 1, an exemplary diagram of a package alarm device 100 is depicted. Device 100 comprises a body 110 which is configured and sized in such a way as to accommodate and support one or more packages. A weight sensor 120 is built into body 110 and is configured to detect the presence of a package thereon. Weight sensor 120 is depicted as a “STOP BUTTON” in FIG. 1, but may also just be a weight sensor under the body surface and not seen by the user. A display screen 130 is built into body 110 and may provide any of a variety of device status information or instructions to a user, for example, a power status indicator 140 or battery charge indicator may be displayed. A package receiving status, such as but not limited to “Ready” 150 may be displayed. Grid extension ports 160 may be provided. Grid expansion ports 160 provide an ability to expand the use of device 100 to accommodate more packages than would otherwise fit on device 100. A power button 170 located in the upper right-side corner controls battery power to the device. In some embodiments power button 170 must be used in cooperation with another device, such as a mobile phone app. A GPS tracking chip is embedded inside device 100. The GPS chip helps to locate device 100 if it's lost or stolen. In an exemplary embodiment, any movement of more than 12 inches will trigger the alarm. In accordance with an alternative exemplary embodiment, device 100 may include a camera 180 which may provide multiple functions. Camera 180 may act as a bar code or other type of scanner in which a delivery person could scan a package being delivered. Camera 180 may also act as a security camera to take pictures of a person who removes a package from the device. Further, camera 180 may be an additional detector to detect and determine when packages have been delivered.

In an exemplary embodiment, a weather resistant seal is in place prior to final assembly in order to decrease the likelihood of damage due to rain, snow, etc. A rechargeable battery provides the necessary power for this device to function. A network card allows connection between the device, and the user's Wi-Fi. A computer processor and motherboard are the brains of this device controlling all this devices' actions. A weight sensor is the activation button triggering the setting of a potential alarm. A motion sensor detects movement of the device so that someone can't just carry it away. If an alarm is triggered because the device is moved or because a packaged is removed from the device, a loud alarm is activated. Grid extension connection ports 160 are where the electrical connection is made when the grid extension use is desired. The grid extension increases the area where weight can be measured so that additional packages are covered. Additional weight will not trigger the motion sensor, but removal of any weight will trigger the motion sensor to activate, which will immediately trigger the alarm to activate with a loud piercing alarm. In an exemplary embodiment, device 100 is connected to Wi-Fi and will report its status to a mobile phone app. For example, device 100 notifies the user that a package has been placed on their device. Display 130 may display important user data such as but not limited to on/off and a ready screen which tells the user that the device is functioning and is set to sound an alarm after a package is placed on device 100. In accordance with an exemplary embodiment, the case of body 100 is made from hard extruded plastic and protects the components inside from deterioration and damage.

In operation, after charging the battery, flipping the power from off to on causes the LED screen to light up, causes the weight sensor to activate, and the user's Wi-Fi connection to be enabled. The weight sensor is located directly in the center of the slightly convex shaped exterior case. On the outside cover there are clear instruction for the delivery driver to place the package on top of the device. Any weight of more than 8 ounces placed upon the device will trigger the motion sensor to activate. This motion sensor will activate a very loud (>100 dB) alarm if any weight is removed. In accordance with an exemplary embodiment, the alarm may be of any type or audio level, however a loud, surprising, or shocking alarm may be more effective, for example, it may be desirable that the alarm be a loud voice based alarm, which may be a recording of a person's voice yelling at the package thief. Additional weight in the form of additional delivery packages will not trigger the alarm.

In an exemplary embodiment, device 100 offers an extension of the grid which expands and retracts thus increasing the grid where weight can be determined. There are additional electrical connections from the device to the extension through ports 160. The alarm is also triggered if the GPS tracking chip inside the device is moved substantially (e.g., more than 12 inches) which helps prevent the package and the device from being stolen together if the motion sensor alarm hasn't activated. Any activation from the weight sensor triggers a notification via the network card/Wi-Fi connection to the user's smart phone app that a package has arrived and has been placed on the device's protective zone. Additionally, the user is notified via the app if any weight has been removed which is often in the form of a package being stolen.

In other exemplary embodiments, if the package is being stolen (i.e., removed from the device prior to deactivating the alarm), not only will the audio alarm sound, but one or more cameras may be triggered to start taking pictures or videos so that the thief may later be identified. Also, if the alarm is activated some systems may be used to alert the authorities (e.g., police) in real-time via the Wi-Fi and internet connection.

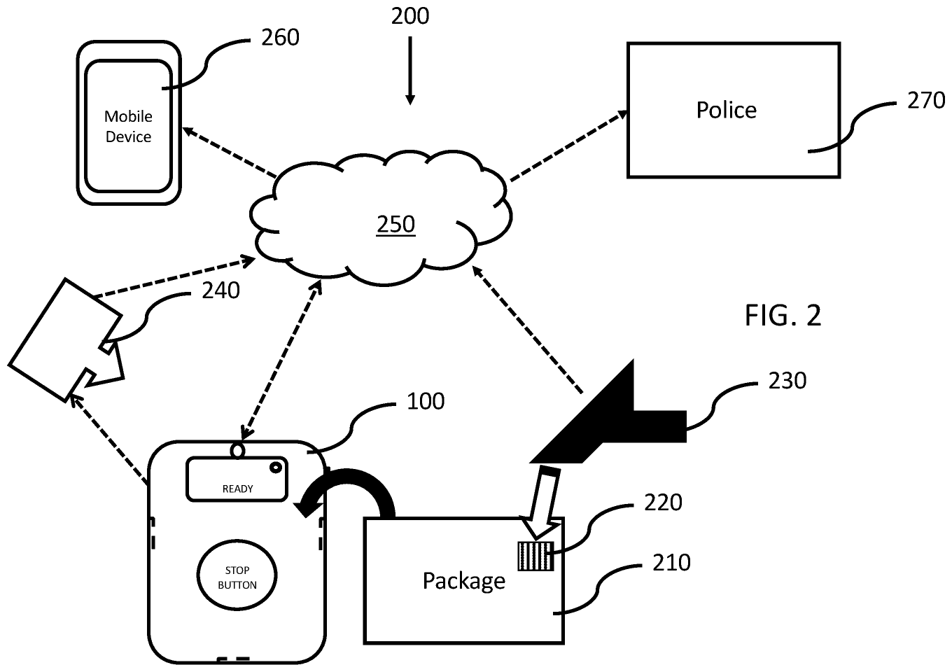

Referring now to FIG. 2, an exemplary system 200 using a device, such as device 100 of FIG. 1, is depicted. In operation, a package being delivered to a residence is scanned whereby the driver scans a package 210 having a barcode 220 or other machine-readable indicia thereon, using a mobile scanning device 230. The package is placed onto device 100 which logs its presence. The mobile device 230 also communicates with the courier service's servers via internet 250 that it has left the package at the residence. This information may also be communicated to an account of the owner's that the package has been left through internet 250 servers and to the owner's mobile device 260. If at some point, a thief removes package 210 from device 100, a series of events then occur. First, a loud audible ring is sounded from device 100. At the same time, one or more cameras 240 (which may also include camera 180 on the device) are awakened and start taking pictures or videos in an effort to try to record the thief's identity. In some embodiments, the Police or building or neighborhood security will be immediately notified in case they are in a nearby location.

If there is a package 210 that has been left on device 100 by a delivery person, when the owner arrives to pick it up, they must first deactivate the alarm of device 100 through an app on their mobile device 260 otherwise they risk triggering the alarm actions.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A delivery package alarm, comprising:
a body portion;
a weight sensor coupled to and supported by the body portion;
a display coupled to the body and providing information about status of the device;
at least one electrical connection for an extension grid for holding and sensing additional packages;
an audio output device coupled within the body; and
a processing device within the body and configured with computer software to identify, based on information from the weight sensor, the presence of a package being delivered, and the processing device configured to detect when the package is removed and produce an alarm sound through the audio output.

2. The delivery package alarm of claim 1, further comprising:
a battery supported within the body, the battery providing power for the electronics of the device.

3. The delivery package alarm of claim 1, further comprising:
an extension grid connector, for providing power to and receiving information from a supplementary weight sensing platform.

4. The delivery package alarm of claim 1, further comprising:
a motion sensor supported within the body and configured to detect motion of the device and communicate that motion to the processing device.

5. The delivery package alarm of claim 1, further comprising:
a global positioning system (GPS) chip supported within the body and configured to detect the location of the device and communicate the location to the processing device.

6. The delivery package alarm of claim 1, further comprising:
a radio frequency (RF) communication circuit supported within the body, the RF communication circuit communicating with the processing device.

7. The delivery package alarm of claim 1, wherein the body is formed of a hard plastic.

8. The delivery package alarm of claim 1, wherein the body includes at least one weather resistant seal.

9. A delivery package alarm system, comprising:
a body portion;
a weight sensor coupled to and supported by the body portion;
a display coupled to the body and providing information about status of the device;
an RF communication circuit;
an audio output device coupled within the body; and
a processing device within the body and configured with computer software to identify, based on information from the weight sensor, the presence of a package being delivered, and the processing device configured to detect when the package is removed and produce an alarm sound through the audio output, communicate with an external camera using the RF communication circuit to begin taking pictures.

10. The delivery package alarm system of claim 9, wherein the processing device software is configured to signal a mobile device, using the RF circuit, when a package is detected to be present.

11. The delivery package alarm system of claim 9, wherein the processing device software is configured to signal a mobile device, using the RF circuit, when a package is detected to be removed.

12. The delivery package alarm system of claim 9, wherein the processing device software is configured to signal an authority, using the RF circuit, when a package is detected to be removed.

13. The delivery package alarm system of claim 9, further comprising:
a motion sensor,
wherein the processing device software is configured to signal a mobile device, using the RF circuit, when the device is detected to be moved by the motion sensor.

14. The delivery package alarm system of claim 9, further comprising:
a motion sensor,
wherein the processing device software is configured to signal an authority, using the RF circuit, when the device is detected to be moved by the motion sensor.

15. The delivery package alarm system of claim 9, further comprising:
a GPS sensor,
wherein the processing device software is configured to send signals to at least one of a mobile device, an authority, or a user account, using the GPS sensor, where the device is located.

16. The delivery package alarm of claim 1, further comprising:
an extension grid connector, for providing power to and receiving information from a supplementary weight sensing platform.

17. The delivery package alarm of claim 1, further comprising:
a global positioning system (GPS) chip supported within the body and configured to detect the location of the device and communicate the location to the processing device.

18. The delivery package alarm of claim 1, wherein the body is formed of a hard plastic.

19. The delivery package alarm of claim 1, wherein the body includes at least one weather resistant seal.

20. A method of alerting that a package is being stolen, comprising:
detecting from a weight sensor that a package has been removed from an electronic weighing device;
producing an audible alarm using an audio output of the weighing device;
requesting by the weighing device that external cameras begin recording;
alerting, by the weighing device, a mobile device that a package has been removed; and
alerting, by the weighing device, an authority that a package has been removed.
